(19) United States
(12) Patent Application Publication
(10) Pub. No.: US 2025/0383585 A1
(43) Pub. Date: Dec. 18, 2025

(54) OPTICAL MODULE

(71) Applicant: TDK TAIWAN CORP., Taoyuan City (TW)

(72) Inventors: Yi-Ho CHEN, Taoyuan City (TW); Chia-Che WU, Taoyuan City (TW); Jui-Che MENG, Taoyuan City (TW)

(21) Appl. No.: 19/237,759

(22) Filed: Jun. 13, 2025

Related U.S. Application Data
(60) Provisional application No. 63/660,046, filed on Jun. 14, 2024.

(51) Int. Cl. G03B 13/36; G03B 3/10; G03B 5/00; G03B 9/22

(52) U.S. Cl. CPC G03B 13/36; G03B 3/10; G03B 5/00; G03B 9/22; G03B 2205/0069

(57) ABSTRACT

An optical module is provided. The optical module includes a first movable part, a fixed part, and a first driving assembly. The first movable part is for connecting a first optical assembly. The first movable part moves relative to the fixed part. The first driving assembly is for driving the first movable part to move.

### CROSS REFERENCE TO RELATED APPLICATIONS

This application claims the benefit of U.S. Provisional Application No. 63/660,046, filed 2024 Jun. 14, the entirety of which is incorporated by reference herein.

### BACKGROUND OF THE INVENTION

### Field of the Invention

The present invention relates to an optical module, and more particularly, it relates to an optical module having multiple optical assemblies, multiple movable parts, and driving assemblies.

### Description of the Related Art

With the advancement of technology, many modern electronic devices (such as computers and tablets) are equipped with photography and video-recording functionality. As the use of these devices becomes more widespread, the development of stable and high-quality optical performance is accompanied by design goals such as convenience and thinness to provide users with more choices.

Conventional aperture structures usually use several blades combined, driven to open or close by a complex mechanical linkage system and drive motors. Such structures involve many moving parts and connections, resulting in a large number of components, complex assembly processes, and high costs. Furthermore, traditional aperture designs require precise multi-level aperture value control, making the structure more sophisticated and complex, thereby increasing the size of the module and making maintenance difficult. This can affect the product's reliability, as well as its lifespan.

In light of the increasing market demand for lightweight, lower-cost optical lenses, how to retain basic aperture control functionality while simplifying the structure, reducing the number of parts, and lowering the cost has become an important issue in optical lens module design.

In response to the above technical problems, the present invention proposes an improved structure wherein an aperture coil arranged inside an autofocus lens drives the aperture blades. Power is controlled via metal terminals and springs. This design not only effectively reduces the number of parts in the aperture drive module and lowers its manufacturing cost, but it also achieves a simplified open-loop aperture control mechanism, meeting the practical needs of the market for low-cost lenses.

### BRIEF SUMMARY OF THE INVENTION

The terms “embodiment,” “arrangement,” “feature,” “example,” and similar terms used in this disclosure broadly refer to all subject matters of the invention and the following claims. Statements containing these terms are not intended to limit the subject matter described herein or the meaning or scope of the claims. The embodiments covered by this invention are defined by the following claims rather than the disclosure content. This summary provides a high-level overview of multiple features of the invention and introduces concepts further described in the embodiment section below. This summary is not intended to identify essential or necessary features of the claimed subject matter, nor is it intended to be used independently to determine the scope of the claims. The subject matter is to be understood with reference to the complete specification, including the accompanying drawings and each of the claims.

According to certain aspects of the present disclosure, an optical module is provided, comprising a first movable part, a fixed part, and a first driving assembly. The first movable part is for connecting a first optical assembly. The first movable part is movable relative to the fixed part. The first driving assembly is for driving the first movable part to move.

According to certain aspects of the present disclosure, the optical module further comprises a second movable part, movable relative to the fixed part. The second movable part includes a first bottom and a carrier. The first bottom connects to the first movable part. The carrier connects to a second optical assembly, wherein the second optical assembly is connected to the first bottom. The first movable part rotates around the main rotational axis. The fixed part includes a housing, and the carrier and the second optical assembly are disposed within the housing. When viewed along the main rotational axis, the geometric center of the housing does not overlap with the main rotational axis, the geometric center of the carrier does not overlap with the main rotational axis, and the geometric center of the first bottom does not overlap with the geometric center of the carrier.

The above summary is not intended to present every embodiment or every feature of the invention. Instead, the above summary provides illustrative examples of some of the novel features and characteristics set forth herein. When combined with the accompanying drawings and appended claims, the advantages and additional features of the invention will become apparent from the representative embodiments and modes of implementation described below. With reference to the drawings and the brief description of symbols provided, additional features of the invention will become evident to those of ordinary skill in the art.

### BRIEF DESCRIPTION OF THE DRAWINGS

The following drawings illustrate exemplary embodiments and, therefore, should not be considered as limiting the various embodiments or the scope of the claims.

FIG. 1 is a perspective view of an optical module, a first optical assembly, and a second optical assembly, according to certain aspects of the present disclosure.

FIG. 2 is a perspective view of the optical module, the first optical assembly, and the second optical assembly, according to certain aspects of the present disclosure, with the upper light-shielding element, the upper cover, and the housing removed for illustrative purposes.

FIG. 3 is an exploded perspective view of the optical module, the first optical assembly, and the second optical assembly, according to certain aspects of the present disclosure.

FIG. 4A is a top view of the first optical assembly, according to certain aspects of the present disclosure.

FIG. 4B is a top view of another first optical assembly, according to another aspect of the present disclosure.

FIG. 5 is a perspective view of the first optical assembly, the first movable part, the first bottom, and the first driving assembly, according to certain aspects of the present disclosure, with the first bottom shown as transparent for illustrative purposes.

FIG. 6 is a perspective view of the optical module, the first optical assembly, and the second optical assembly in a second state, according to certain aspects of the present disclosure, with the upper light-shielding element, the upper cover, and the housing removed for illustrative purposes.

FIG. 7 is a bottom view of the optical module, the first optical assembly, and the second optical assembly, according to certain aspects of the present disclosure.

FIG. 8 is a cross-sectional view taken along line C-C in FIG. 1 of the optical module, the first optical assembly, and the second optical assembly, according to certain aspects of the present disclosure.

FIG. 9A is a partial enlarged view of area a in FIG. 8, showing the optical module, the first optical assembly, and the second optical assembly, with the first movable part and the first optical assembly in a first state, according to certain aspects of the present disclosure.

FIG. 9B is a partial enlarged view of area a in FIG. 8 showing the optical module, the first optical assembly, and the second optical assembly, with the first movable part and the first optical assembly in a second state, according to certain aspects of the present disclosure.

### DETAILED DESCRIPTION OF THE INVENTION

Various embodiments are described with reference to the drawings, in which like reference numerals designate similar or equivalent components throughout the figures. The drawings are not drawn to scale and are provided merely to illustrate the features and characteristics of the present disclosure. It should be understood that many specific details, relationships, and methods are set forth to provide a thorough understanding. However, those skilled in the art will appreciate that various embodiments may be practiced without one or more of the specific details or using other methods. In some instances, well-known structures or operations are not shown in detail for brevity. Various embodiments are not limited by the sequence of acts or events shown, as some acts may occur in different orders and/or concurrently. Furthermore, not all illustrated acts or events are required for implementing some features and characteristics of this disclosure.

For the purposes of the present embodiments, unless explicitly stated otherwise, singular forms include plural forms and vice versa. The terms “including” shall mean “including but not limited to.” Additionally, approximation terms such as “about,” “almost,” “substantially,” and “approximately,” may refer to “at,” “near,” “within 3-5%,” “within acceptable manufacturing tolerances,” or any logical combination thereof. Directional terms such as “top,” “bottom,” “left,” “right,” “upper,” and “lower” refer to directions shown in the reference figures or understood from context.

It is understood that although terms such as “first” and “second” may be used to describe various components, layers, and/or parts, these components, layers, and/or parts should not be limited by these terms. These terms are only used to distinguish different elements. Accordingly, a first element discussed below could be termed a second element, and vice versa, without departing from the teachings of some embodiments. Furthermore, for simplicity, the description may not use “first” and “second” labels to distinguish different components. The claims may refer to first and/or second elements, which are interpreted according to the specification.

It should be noted that the technical solutions provided in different embodiments below may be interchangeably or combinatorially used to constitute another embodiment, without departing from the spirit of the disclosure.

The present disclosure relates to an optical module with multiple movable parts and driving assemblies. It may provide various motions and compound deformations and adjustments of multiple optical assemblies, enabling more precise or versatile optical control to adapt to different imaging requirements.

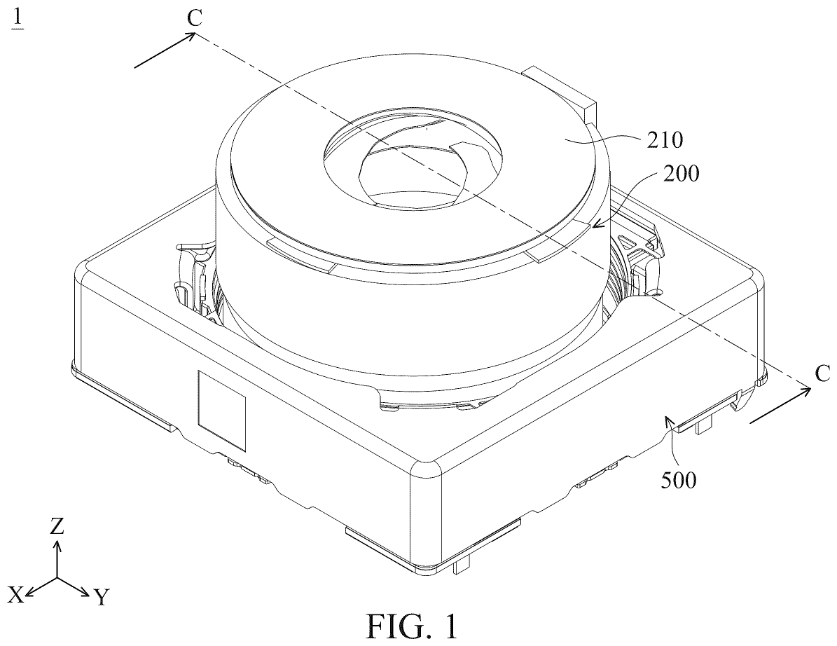

Please refer to FIG. 1 to FIG. 3 first. FIG. 1 is a perspective view of an optical module 1, a first optical assembly 10, and a second optical assembly 20, according to certain aspects of the present disclosure.

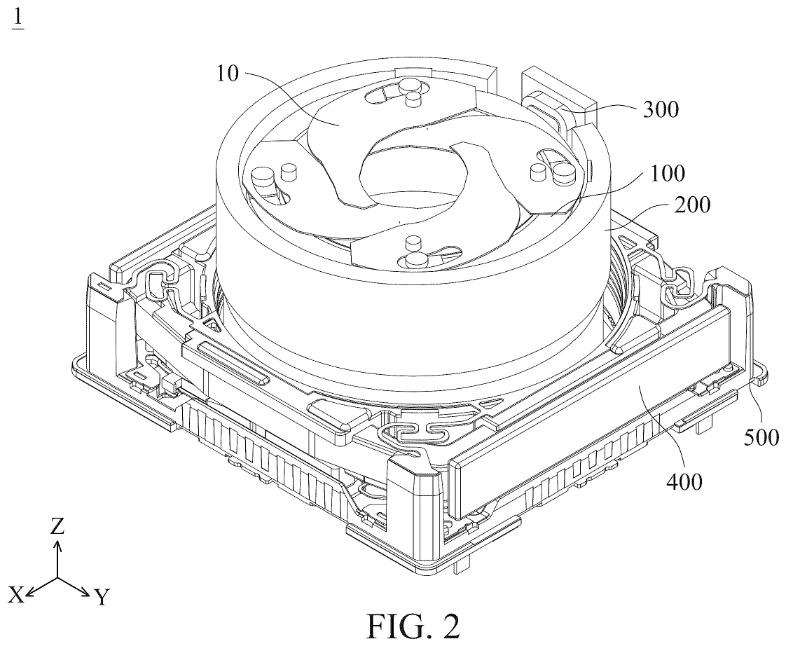

FIG. 2 is a perspective view of the optical module 1, the first optical assembly 10, and the second optical assembly 20, according to certain aspects of the present disclosure, with the upper light-shielding element 210, the upper cover 220, and the housing 510 removed for illustrative purposes.

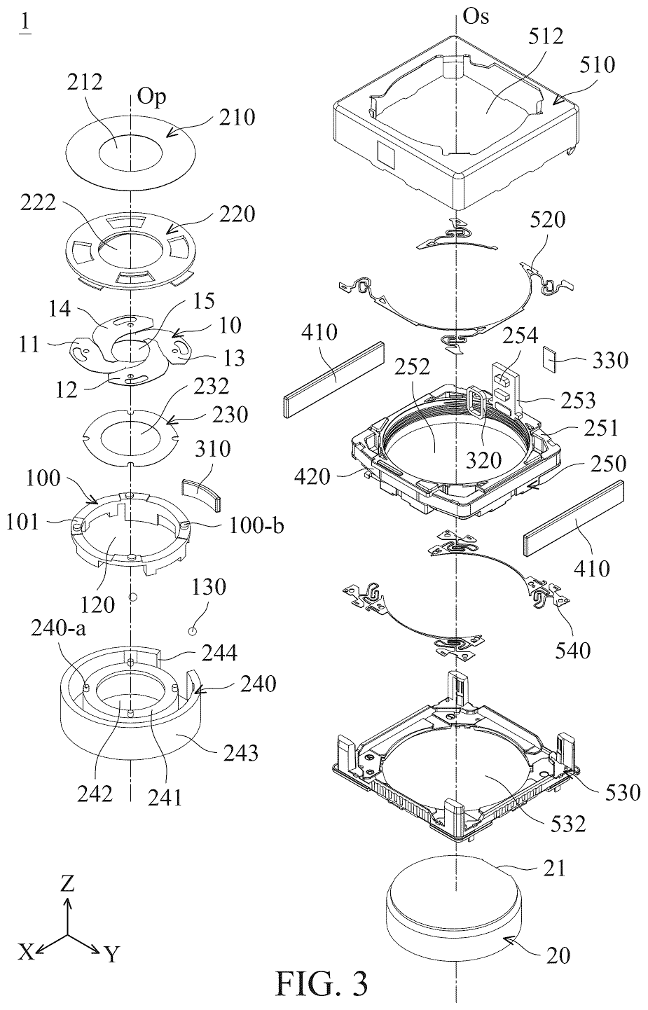

FIG. 3 is an exploded perspective view of the optical module 1, the first optical assembly 10, and the second optical assembly 20, according to certain aspects of the present disclosure.

The optical module 1 includes a first movable part 100, a second movable part 200, a first driving assembly 300, a second driving assembly 400, and a fixed part 500. The first movable part 100 is connected to a first optical assembly 10, which may be, for example, a set of optical blades. The first movable part 100 is movable relative to the second movable part 200 and the fixed part 500. The second movable part 200 is connected to a second optical assembly 20, which may be, for example, an optical lens which includes a recess 21. The second movable part 200 is movable relative to the fixed part 500. The first driving assembly 300 drives the first movable part 100 to move. The second driving assembly 400 drives the second movable part 200 to move. Incident light from an external source travels through the optical module 1 to reach the first optical assembly 10 along an incident direction, which defines the main rotational axis Op of the first optical assembly 10.

The first optical assembly 10 and the first movable part 100 move relative to the second movable part 200 through the actuation of the first driving assembly 300 to control the optical blades and adjust the amount of the incident light. The first optical assembly 10, first movable part 100, and second movable part 200 are disposed on the second optical assembly 20 and move relative to the fixed part 500 through the actuation of the second driving assembly 400 to achieve autofocus (AF) functionality, as will be described in detail with reference to the figures below.

The first optical assembly 10 includes multiple blades. In this embodiment, there are four blades, but in other embodiments, more or fewer blades may be used as required. These multiple blades form an aperture 15 of the first optical assembly 10, through which the incident light enters along the main rotational axis Op.

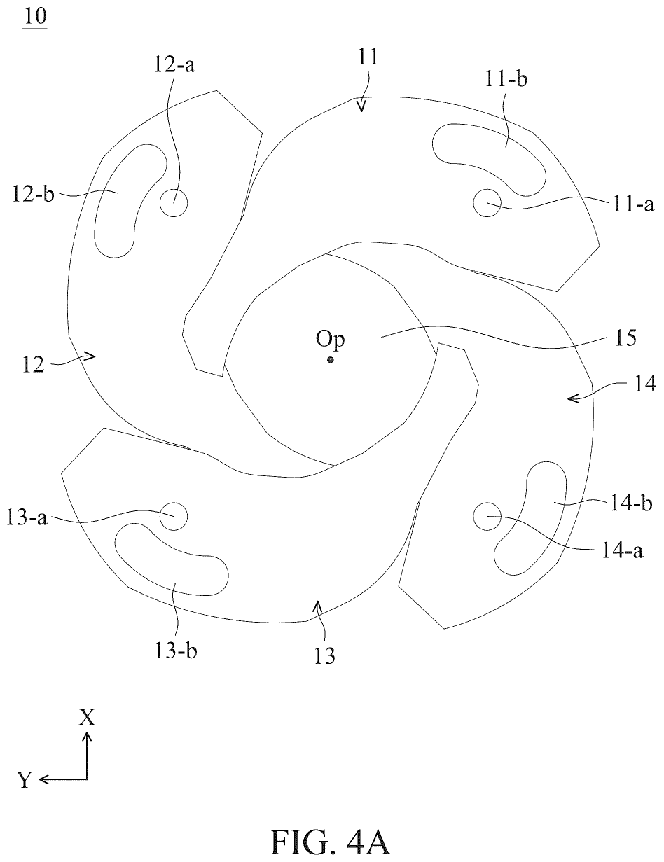

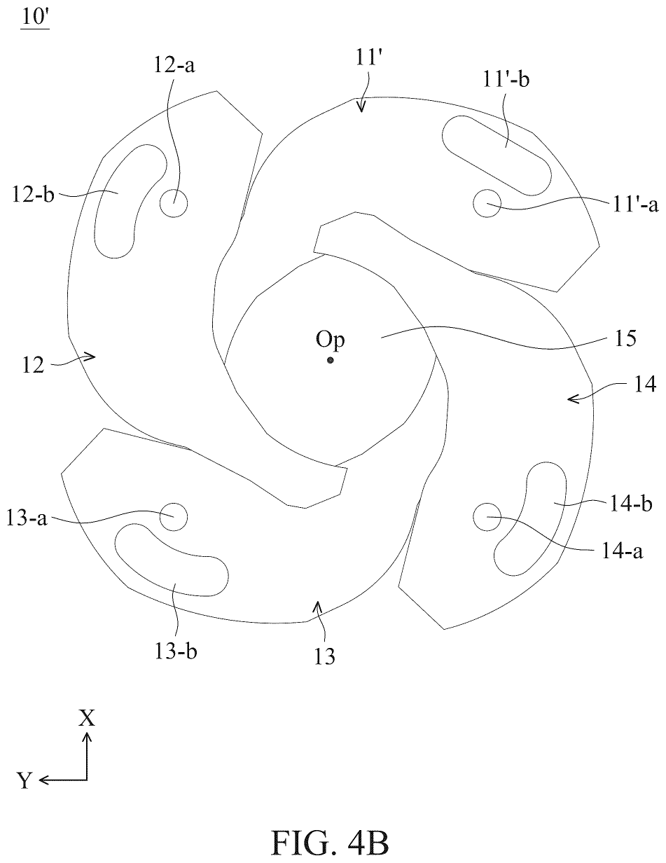

Next, please refer to FIG. 4A, which is a top view of the first optical assembly 10 according to certain aspects of the present disclosure. In this embodiment, the first optical assembly 10 includes a first blade 11, a second blade 12, a third blade 13, and a fourth blade 14. The first blade 11 and the second blade 12 are located on opposite sides of the main rotational axis Op. The third blade 13 and the fourth blade 14 are also located on opposite sides of the main rotational axis Op. The first blade 11 includes a first rotation portion 11-a and a first guiding portion 11-b. The first blade 11 is connected to the second movable part 200 via the first rotation portion 11-a and is connected to the first movable part 100 via the first guiding portion 11-b. Similarly, the second blade 12 includes a second rotation portion 12-a and a second guiding portion 12-b. The second blade 12 is connected to the second movable part 200 via the second rotation portion 12-a and is connected to the first movable part 100 via the second guiding portion 12-b. The third blade 13 includes a third rotation portion 13-a and a third guiding portion 13-b. The third blade 13 is connected to the second movable part 200 via the third rotation portion 13-a and is connected to the first movable part 100 via the third guiding portion 13-b. The fourth blade 14 includes a fourth rotation portion 14-a and a fourth guiding portion 14-b. The fourth blade 14 is connected to the second movable part 200 via the fourth rotation portion 14-a and is connected to the first movable part 100 via the fourth guiding portion 14-b.

Please refer to FIG. 4B next. FIG. 4B is a top view of another configuration of the first optical assembly 10′. In this configuration, the first blade 11′ and the second blade 12 (or the third blade 13 and fourth blade 14) have different shapes. For example, the first guiding portion 11′-b and the second guiding portion 12-b differ in shape, such that the shortest distance between the first guiding portion 11′-b and the corresponding first rotation portion 11′-a differs from that of the second guiding portion 12-b and the corresponding second rotation portion 12-a. This produces differentiated blade motion paths or control characteristics. The first blade 11′ and the second blade 12 are located on opposite sides of the main rotational axis Op, and may generate asymmetric optical blocking or reflection effects. For example, in certain states, the first blade 11′ may reduce the aperture 15 more than the second blade 12, thereby blocking more incident light passing through the aperture 15 of the first optical assembly 10.

Please refer back to FIG. 3. The first movable part 100 includes an upper surface 101, an opening 120, and multiple guiding elements 130. The upper surface 101 faces the first blade 11 of the first optical assembly 10, and multiple guiding protrusions 100-b are formed on the upper surface 101. In this embodiment, there are four guiding protrusions 100-b, respectively connected to the guiding portions 11-b, 12-b, 13-b, and 14-b of the first blade 11, the second blade 12, the third blade 13, and the fourth blade 14. A first magnetic element 310 of the first driving assembly 300 is disposed on the first movable part 100, so that the first movable part 100 is rotatable relative to the second movable part 200 around the main rotational axis Op of the first optical assembly 10 through the driving of the first driving assembly 300.

The guiding elements 130 may be spherical and are disposed between the first movable part 100 and the second movable part 200. In this embodiment, there are two guiding elements 130 (only one guiding element 130 is marked in FIG. 3). The first movable part 100 is movably connected to a first bottom 240 of the second movable part 200 through the guiding elements 130. When the first movable part 100 is actuated by the first driving assembly 300, the guiding elements 130 roll between the first bottom 240 and the first movable part 100, thereby allowing the first movable part 100 to move smoothly relative to the first bottom 240.

The second movable part 200 includes an upper light-shielding element 210, an upper cover 220, a lower light-shielding element 230, the first bottom 240, and a carrier 250. The first bottom 240 connects to the first movable part 100, while the carrier 250 is for carrying the second optical assembly 20, and the second optical assembly 20 is connected to the first bottom 240. This configuration allows the first optical assembly 10 and the second optical assembly 20 to be adjusted in focal length through the movement of the second movable part 200.

The upper light-shielding element 210 may be made of light-absorbing material, such as SOMA, and includes an opening 212 to allow incident light to pass through. The upper cover 220 is disposed above the first optical assembly 10 and is connected to the first bottom 240. It also includes an opening 222. The first optical assembly 10 is located between the lower light-shielding element 230 and the upper cover 220. The upper cover 220 at least partially covers the first optical assembly 10 to protect the internal components of the optical module 1 from external impacts. The lower light-shielding element 230 also has an opening 232 and may be made of light-absorbing material, such as SOMA, to prevent stray light from affecting the imaging performance of the second optical assembly 20.

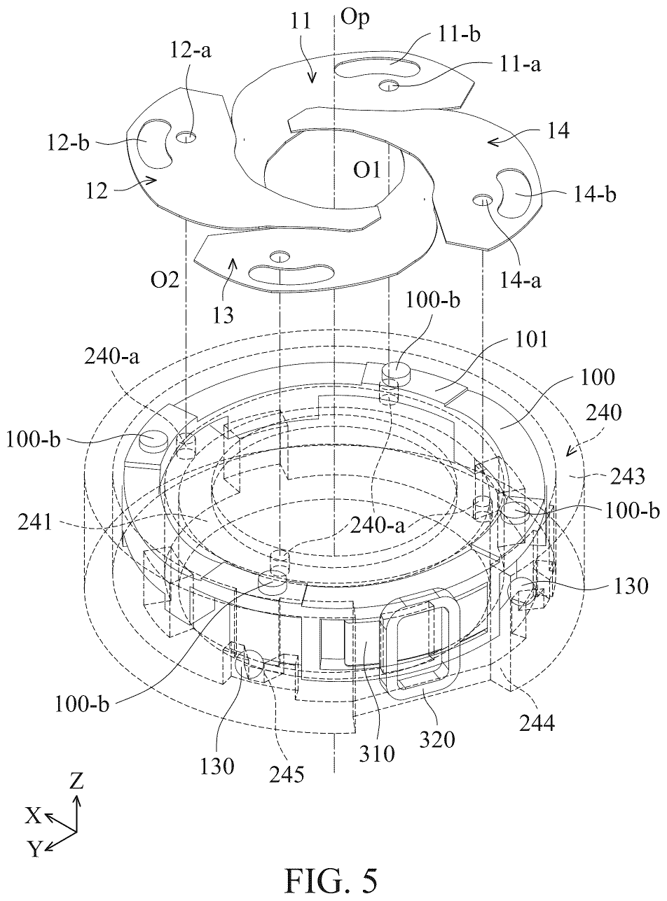

The first bottom 240 includes an inner wall 241, an outer wall 243, an opening 242, and a notch 244. The first movable part 100 is connected to the first bottom 240 via the guiding elements 130 and the first movable part 100 is housed between the inner wall 241 and the outer wall 243. The outer wall 243 may be provided with multiple groove structures 245 (as shown in FIG. 5) to accommodate the guiding elements 130 and control their rolling movement. Incident light passes through the opening 242 to reach the second optical assembly 20. The notch 244 corresponds to the first magnetic element 310 of the first driving assembly 300, allowing smooth operation between the magnetic element and the coil (will be explained in detail further down below with reference to FIG. 5).

The carrier 250 includes a main body 251, an opening 252, and a support structure 253. The support structure 253 extends upward from the main body 251 and includes a protruding portion 254 to which the coil 320 of the first driving assembly 300 is fixed. The position of the coil 320 corresponds to the position of the first magnetic element 310, such that the notch 244 of the first bottom 240 aligns with the position of the support structure 253 of the carrier 250. The second optical assembly 20 is disposed within the opening 252.

The first driving assembly 300 is an electromagnetic driving assembly including a first magnetic element 310, a coil 320, and a magnetic guiding element 330. The first magnetic element 310 is disposed on the first movable part 100. The coil 320 is disposed on the support structure 253 of the carrier 250. Through the electromagnetic force generated between the first magnetic element 310 and the coil 320, the first magnetic element 310 moves relative to the coil 320. Accordingly, the first movable part 100 moves relative to the first bottom 240 and the carrier 250, thereby driving the movement of the first optical assembly 10. Therefore, the first movable part 100, driven by the electromagnetic force between the first magnetic element 310 and the coil 320, moves the first optical assembly 10 relative to the first bottom 240 and the carrier 250.

The magnetic guiding element 330 is also disposed on the support structure 253 and exerts an attractive force on the first magnetic element 310. This causes the first movable part 100 to be attracted toward the second movable part 200, thereby enhancing structural stability. At the same time, the presence of the magnetic guiding element 330 strengthens the overall structural integrity of the support structure 253, thereby improving the reliability of the optical module 1.

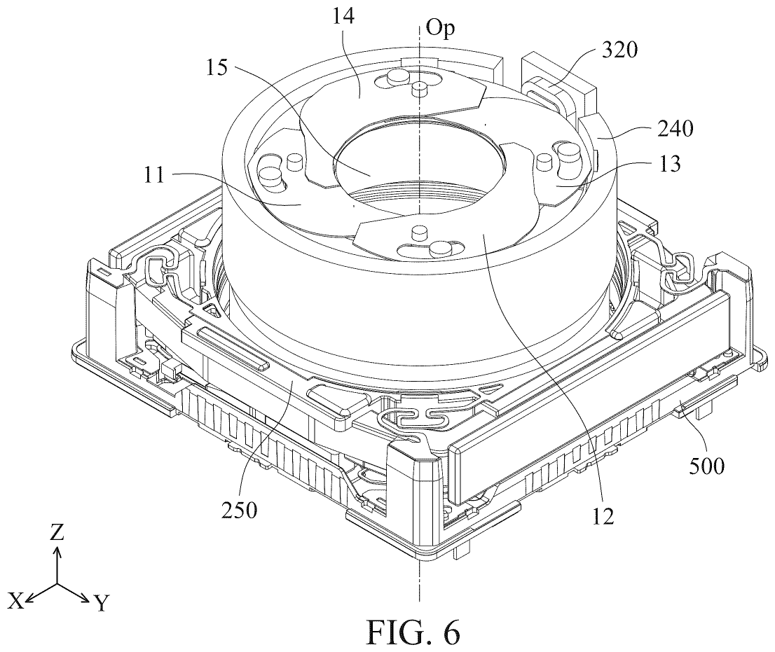

Please refer to FIGS. 3 to 6 together. FIG. 5 is a perspective view of the first optical assembly 10, the first movable part 100, the first bottom 240, and the first driving assembly 300, according to certain aspects of the present disclosure. For illustrative purposes, the first bottom 240 is shown as transparent. FIG. 6 is a perspective view of the optical module 1, the first optical assembly 10, and the second optical assembly 20 in a second state, according to certain aspects of the present disclosure. For illustrative purposes, the upper light-shielding element 210, the upper cover 220, and the housing 510 are removed.

The first movable part 100 is connected to the first blade 11, the second blade 12, the third blade 13, and the fourth blade 14 of the first optical assembly 10. The first movable part 100 and the blades may move relative to the first bottom 240. The first movable part 100 includes four guiding protrusions 100-b, respectively inserted into the corresponding one of the first guiding portion 11-b of the first blade 11, the second guiding portion 12-b of the second blade 12, the third guiding portion 13-b of the third blade 13, and the fourth guiding portion 14-b of the fourth blade 14. These guiding protrusions 100-b are movable within the respective one of the first guiding portion 11-b, the second guiding portion 12-b, the third guiding portion 13-b, and the fourth guiding portion 14-b.

The first bottom 240 includes four rotation protrusions 240-a, respectively inserted into the corresponding one of the first rotation portion 11-a of the first blade 11, the second rotation portion 12-a of the second blade 12, the third rotation portion 13-a of the third blade 13, and the fourth rotation portion 14-a of the fourth blade 14. One of the rotation protrusions 240-a may rotate within the first rotation portion 11-a about a first axis 01. Another one of the rotation protrusions 240-a may rotate within the second rotation portion 12-a about a second axis 02. Similarly, another one of the rotation protrusions 240-a may rotate within the third rotation portion 13-a. Another one of the rotation protrusions 240-a may rotate within the fourth rotation portion 14-a.

Through the interaction between the guiding protrusions 100-b and rotation protrusions 240-a with the corresponding one of the first guiding portion 11-b, the second guiding portion 12-b, the third guiding portion 13-b, and the fourth guiding portion 14-b and the first rotation portion 11-a, the second rotation portion 12-a, the third rotation portion 13-a, and the fourth rotation portion 14-a, the first blade 11, the second blade 12, the third blade 13, and fourth blade 14 are connected to both the first movable part 100 and the first bottom 240.

When the first movable part 100 is actuated by the first driving assembly 300, the four guiding protrusions 100-b move within the respective one of the first guiding portion 11-b, the second guiding portion 12-b, the third guiding portion 13-b, and the fourth guiding portion 14-b, while the four rotation protrusions 240-a rotate within the respective one of the first rotation portion 11-a, the second rotation portion 12-a, the third rotation portion 13-a, and the fourth rotation portion 14-a. This drives the motion of the first blade 11, the second blade 12, the third blade 13, and fourth blade 14. By moving the first blade 11, the second blade 12, the third blade 13, and fourth blade 14 together, the size of the aperture 15 formed by the first blade 11, the second blade 12, the third blade 13, and fourth blade 14 may be adjusted.

In a first state, as shown in FIG. 2, the first movable part 100 and the first blade 11, the second blade 12, the third blade 13, and fourth blade 14 are positioned such that the aperture 15 formed by the first blade 11, the second blade 12, the third blade 13, and fourth blade 14 is smaller, allowing a limited amount of incident light to pass through to reach the first optical assembly 10.

In a second state, as shown in FIG. 6, the first movable part 100 and the first blade 11, the second blade 12, the third blade 13, and fourth blade 14 are positioned such that the aperture 15 formed by the first blade 11, the second blade 12, the third blade 13, and fourth blade 14 is larger than that in the first state, allowing a greater amount of incident light to reach the first optical assembly 10.

Please refer back to FIG. 3 next. The second driving assembly 400 is an electromagnetic driving assembly that includes two second magnetic elements 410 and a coil 420. The second magnetic elements 410 are disposed on the fixed part 500. The coil 420 is disposed on the carrier 250 and surrounds the main body 251 of the carrier 250. Through the electromagnetic force generated between the second magnetic elements 410 and the coil 420, the coil 420 moves relative to the second magnetic elements 410. Accordingly, the carrier 250 (along with the first bottom 240, the first optical assembly 10, and the first movable part 100) moves relative to the fixed part 500. The second optical assembly 20 moves with the carrier 250. The second driving assembly 400 thus drives the second movable part 200, carrying the second optical assembly 20 (and the first bottom 240, the first optical assembly 10, and the first movable part 100), to move relative to the fixed part 500.

Unlike the first driving assembly 300, which is a moving magnet type (where the magnetic element 310 moves relative to the coil 320, causing movement of the first movable part 100 relative to the first bottom 240), the second driving assembly 400 is a moving coil type. In this configuration, the coil 420 moves relative to the second magnetic elements 410, causing movement of the carrier 250 relative to the fixed part 500.

The fixed part 500 includes a housing 510, a first circuit element 520, a second bottom 530, and a second circuit element 540. The housing 510 includes an opening 512 through which incident light passes. The first circuit element 520 and the second circuit element 540 are flexible metal components that connect the second bottom 530 and the carrier 250. The first circuit element 520 electrically connects the carrier 250 to the coil 320. The second circuit element 540 electrically connects the carrier 250 to the second bottom 530.

The second bottom 530 includes an opening 532 for accommodating the second optical assembly 20. The housing 510 and the second bottom 530 are fixedly connected to house the first circuit element 520, the carrier 250, the second driving assembly 400, and the second circuit element 540. The structure of the housing 510 provides support and positioning functions for the entire optical module 1.

When viewed along the incident direction of the incident light, the first optical assembly 10, the first movable part 100, the first bottom 240, the housing 510, the carrier 250, and the second bottom 530 are sequentially arranged.

When viewed along the incident direction of the incident light, the incident light sequentially passes through the opening 212 of the upper light-shielding element 210, the opening 222 of the upper cover 220, the aperture 15 of the first optical assembly 10, the opening 232 of the lower light-shielding element 230, the opening 120 of the first movable part 100, the opening 242 of the first bottom 240, the opening 512 of the housing 510, and reaches the second optical assembly 20 disposed on the carrier 250.

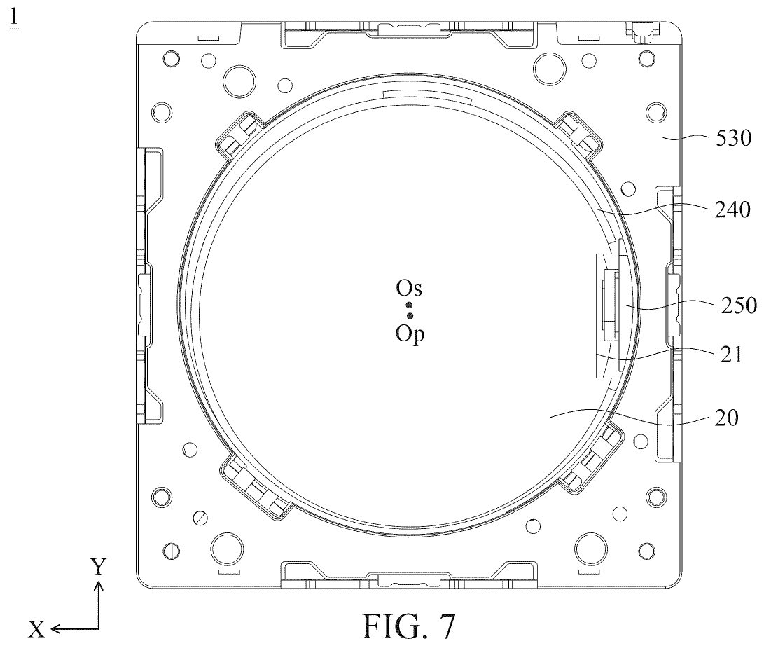

Please refer to FIGS. 3 and 7 together. FIG. 7 is a bottom view of the optical module 1, the first optical assembly 10, and the second optical assembly 20, according to certain aspects of the present disclosure.

The main rotational axis Op is the rotational center of the first optical assembly 10. The geometric centers of the first movable part 100, the first optical assembly 10, the second optical assembly 20, the upper light-shielding element 210, the upper cover 220, the lower light-shielding element 230, and the first bottom 240 of the second movable part 200 are all aligned along the main rotational axis Op.

The geometric centers of the housing 510 of the fixed part 500, the carrier 250 of the second movable part 200, and the second bottom 530 are aligned along the secondary axis Os. In some cases, the main rotational axis Op and the secondary axis Os do not coincide. In other words, when viewed along the main rotational axis Op (i.e., the incident light direction), the geometric centers of the housing 510, the carrier 250, and the first bottom 240 do not overlap with each other.

The recess 21 of the second optical assembly 20 prevents collision with the carrier 250 and the coil 320 during movement, thereby expanding the module's adjustment range and design flexibility, and reducing interference.

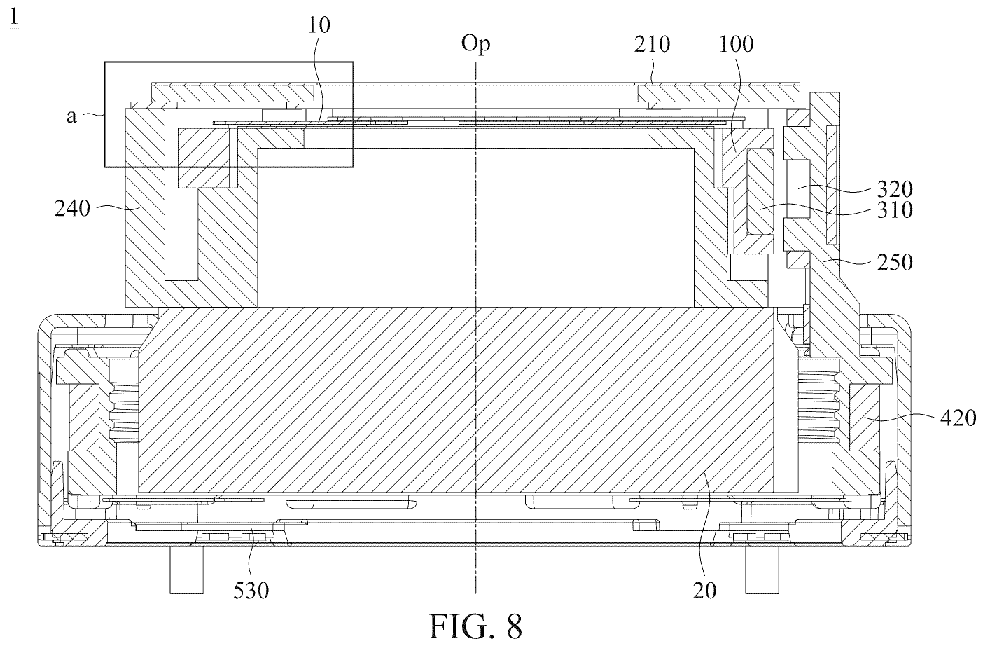

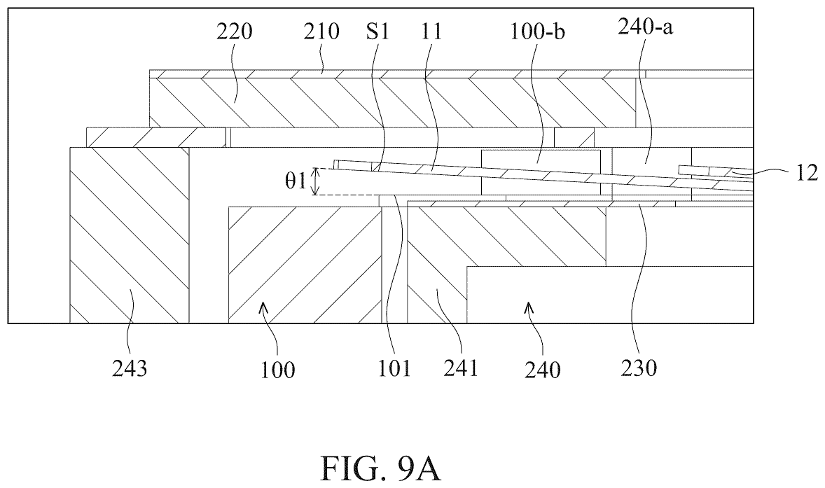

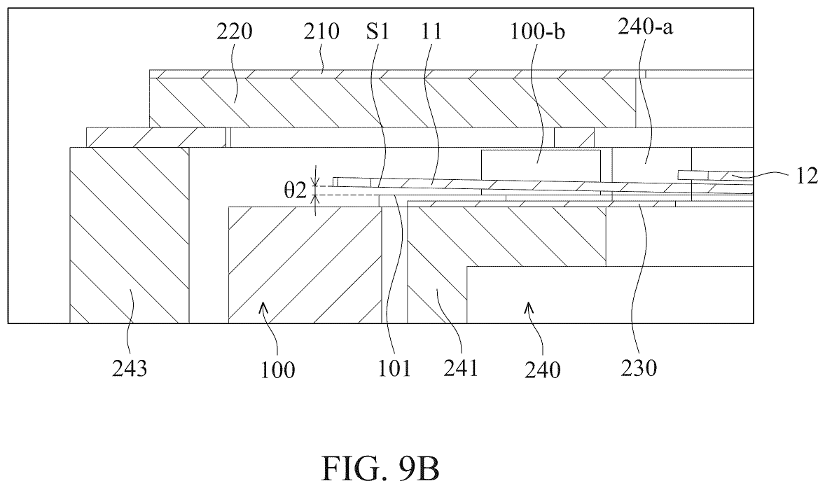

Please refer to FIGS. 8 to 9B together. FIG. 8 is a cross-sectional view taken along line C-C in FIG. 1, showing the optical module 1, the first optical assembly 10, and the second optical assembly 20, according to certain aspects of the present disclosure.

FIG. 9A is a partially enlarged view of area a in FIG. 8, showing the first movable part 100, the first optical assembly 10, and the second optical assembly 20, according to certain aspects of the present disclosure, wherein the first movable part 100 and the first optical assembly 10 are in a first state.

FIG. 9B is a partially enlarged view of area a in FIG. 8, showing the first movable part 100, the first optical assembly 10, and the second optical assembly 20, according to certain aspects of the present disclosure, wherein the first movable part 100 and the first optical assembly 10 are in a second state.

In some embodiments, a first blade surface S1 of the first blade 11 is not parallel to the upper surface 101 of the first movable part 100. When the first movable part 100 is in the first state, as shown in FIGS. 2 and 9A, a first angle θ1 is formed between the first blade surface S1 and the upper surface 101 of the first movable part. When the first movable part 100 is in the second state, as shown in FIGS. 6 and 9B, a second angle θ2 is formed between the first blade surface S1 and the upper surface 101. That is, when the first movable part 100 is in different states or at different rotation angles, the first blade surface S1 of the first blade 11 forms different angles (e.g., the first angle and the second angle) with the upper surface 101. This allows for dynamic adjustment of the blade's orientation or effect on the optical path, achieving a dynamic shading or modulation function.

In summary, the optical module disclosed in this embodiment includes multiple movable parts and optical assemblies. The movement of the first driving assembly drives the first movable part relative to the second movable part, thereby adjusting the position of the blades and controlling the amount of incident light reaching the first optical assembly to suit different imaging needs. The movement of the second driving assembly drives the second movable part relative to the fixed part, allowing for lens position adjustment to achieve autofocus and maintain stable optical quality. This structure achieves complex optical adjustments within a limited space and with fewer components, making it suitable for applications such as camera modules and optical instruments.

Although one or more embodiments of the present invention have been illustrated and described, those skilled in the art will readily understand and recognize modifications and equivalents after reviewing this specification and the drawings. In addition, although certain features may have been described in the context of a single embodiment, these features may be combined with one or more features from other embodiments where desirable and practicable.

While various embodiments of the present invention have been described above, it should be understood that they are presented by way of example rather than limitation. Without departing from the spirit or scope of the present invention, various modifications may be made. Therefore, the breadth and scope of the present invention should not be limited by any of the above-described exemplary embodiments. Rather, the scope of the invention should be defined by the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, the terms “including,” “comprising,” “having,” and variants thereof are intended to be inclusive, in a manner similar to the term “comprising” as interpreted when employed as a transitional word in a claim.

What is claimed is:

1. An optical module, comprising:
a first movable part, configured to connect to a first optical assembly;
a fixed part, wherein the first movable part is movable relative to the fixed part; and
a first driving assembly, configured to drive the first movable part to move.

2. The optical module as claimed in claim 1, further comprising a second movable part, movable relative to the fixed part, wherein the second movable part comprises:
a first bottom, connected to the first movable part; and
a carrier, connected to a second optical assembly, wherein the second optical assembly is connected to the first bottom.

3. The optical module as claimed in claim 2, wherein:
the first movable part is rotatable around a main rotational axis; and
the fixed part comprises a housing, wherein the carrier and the second optical assembly are disposed within the housing.

4. The optical module as claimed in claim 3, wherein when viewed along the main rotational axis:
a geometric center of the housing does not overlap with the main rotational axis;
a geometric center of the carrier does not overlap with the main rotational axis; and
a geometric center of the first bottom does not overlap with the geometric center of the carrier.

5. The optical module as claimed in claim 3, wherein the first optical assembly comprises:
a first blade, having a blade surface; and
a second blade, wherein when viewed along the main rotational axis, the first and second blades are disposed on opposite sides of the main rotational axis.

6. The optical module as claimed in claim 5, wherein the second blade has a different shape than the first blade.

7. The optical module as claimed in claim 5, wherein the first movable part comprises:
an upper surface, facing the first blade; and
a plurality of guiding protrusions, formed on the upper surface, connected to the first blade and the second blade respectively.

8. The optical module as claimed in claim 6, wherein:
when in a first state, an angle between the blade surface and the upper surface is a first angle;
when in a second state, the angle is a second angle.

9. The optical module as claimed in claim 8, wherein the first angle is different from the second angle.

10. The optical module as claimed in claim 7, wherein the first blade comprises:
a first rotational portion, rotatable around the main rotational axis; and
a first guiding portion, wherein one of the guiding protrusions connects the first blade via the first guiding portion.

11. The optical module as claimed in claim 10, wherein the second blade comprises:
a second rotational portion, rotatable around the main rotational axis; and
a second guiding portion, wherein another one of the guiding protrusions connects the second blade via the second guiding portion.

12. The optical module as claimed in claim 11, wherein the first guiding portion and the second guiding portion have different shapes.

13. The optical module as claimed in claim 11, wherein a shortest distance between the first rotational portion and the first guiding portion is different from a shortest distance between the second rotational portion and second guiding portion.

14. The optical module as claimed in claim 2, wherein the first driving assembly comprises:
a first magnetic element, disposed on the first movable part;
a coil, disposed on the carrier.

15. The optical module as claimed in claim 14, further comprising a second driving assembly, configured to drive the second movable part relative to the fixed part, wherein the second driving assembly comprises:
at least one second magnetic element, disposed on the fixed part; and
a coil, disposed on the carrier.

16. The optical module as claimed in claim 15, wherein the coil of the second driving assembly moves relative to the fixed part, and the first magnetic element of the first driving assembly moves relative to the fixed part.

17. The optical module as claimed in claim 3, wherein the fixed part comprises:
a housing, having an opening;
a second bottom;
a first circuit element, electrically connecting the carrier to the first driving assembly; and
a second circuit element, connecting the carrier to the second bottom.

18. The optical module as claimed in claim 17, wherein the housing and the second bottom are fixedly joined to enclose the first circuit element, the second circuit element, the carrier, and the second driving assembly.

19. The optical module as claimed in claim 2, wherein the second optical assembly includes a recess, in proximity with the first driving assembly.

20. The optical module as claimed in claim 1, wherein the first optical assembly, the second optical assembly, the first movable part, and the first bottom of the second movable part are aligned along the main rotational axis, and the housing, the carrier of the second movable part, and the second bottom are aligned along a secondary axis, wherein the secondary axis does not coincide with the main rotational axis.
